(19) United States
(12) Patent Application Publication
(10) Pub. No.: US 2004/0030765 A1
(43) Pub. Date: Feb. 12, 2004

(54) Local network natification

(76) Inventors: Itai Ephraim Zilbershtein, Petach-Tikva (IL); Emek Sadot, Givatayim (IL)

Correspondence Address: Docket Administrator (Room 1N-391), Avaya Inc., 307 Middletown-Lincroft Road, Lincroft, NJ, 07738, US

(21) Appl. No.: 10/217,069

(22) Filed: Aug. 12, 2002

(51) Int. Cl. G06F 15/173

(52) U.S. Cl. 709/223

(57) ABSTRACT

A method of providing policy enforcement within a network. The method includes receiving a packet by a first network element at an entrance to the network, replacing a value of an address field of the packet to an internal address related to a policy profile according to which the packet is to be handled, forwarding the packet to a second network element in the network, and handling the packet in accordance with a policy profile determined from the internal address in the address field of the packet.

### FIELD OF THE INVENTION

The present invention relates to data communication networks and in particular to changing packets by an intermediate element of a network.

### BACKGROUND OF THE INVENTION

Data networks are widely used to allow fast communication between end-stations (e.g., computers), within organizations and between organizations. Data networks are generally packet based networks which, unlike switched networks, do not establish a unique physical link path between a source and destination. Rather, the messages passed between the end-stations are encapsulated in packets which carry destination addresses (e.g., IP addresses and MAC addresses). Switches and/or routers along the network direct the packets to their destinations based on the destination addresses.

Some network elements, for example some types of load balancers and proxies, replace the destination addresses and optionally destination ports of packets they forward toward servers. This replacement, referred to as half NAT (Network Address Translation), is used to direct the packets to one of a plurality of servers. Generally, an opposite replacement is performed for packets from the servers back to clients. Some of these networks also change the source addresses, and optionally source ports, of the packets they forward to servers, in a procedure referred to as full NAT. Full NAT is generally used when it is required that bi-directional IP flows between a source and destination all pass through the NAT-performing network element, regardless of the network topology. The source addresses used generally direct the return packets to the NAT-performing network element.

The addresses to which the address fields of a packet are replaced in the NAT process are generally selected arbitrarily, for example from a predetermined bank of addresses. In some cases, however, the replacement is performed based on the interface through which the packet is received.

In many cases, a message or a sequence of related messages (e.g., a data file or a video movie) transmitted between computers is encapsulated within a plurality of packets which carry the same addressing information. These packets are referred to as belonging to a single connection. In many cases, while a message is being transmitted from a source computer to a destination, the destination transmits responses to the source computer. In the present application, the transmissions from the source to the destination and from the destination to the source are considered as belonging to two different connections which together form a two-way connection.

Network connections between computers, although very important, carry with them the danger of unauthorized entrance through the network to computers which hold sensitive information. Many routers and switches check packets which they forward for adherence to security rules. Generally, the security rules are preprogrammed by a network manager in charge of the router or switch. Packets which do not adhere to pre-programmed security rules are logged and/or discarded in order to prevent, for example, illegal intrusion to computers or other end-stations of a local area network (LAN), from computers external to the LAN. This behavior is also referred to as access control.

In addition to access control, routers and/or switches may also implement other policy enforcement rules, such as, providing different handling to packets with different quality of service (QoS) levels, counting packets belonging to certain connections (and/or having certain additional characteristics), and passing specific frames to a sniffing station in addition to forwarding the packets to their destination.

Many organizations use, in addition to the access control performed by their routers and/or switches, a firewall which checks packets for adherence to more stringent security rules than those implemented by routers and switches. The firewall is usually a software program that runs on an edge-router at the entrance to an organization, or on a dedicated processor sometimes referred to in itself as a firewall.

In some cases, the access control rules implemented by routers and/or switches within the network are governed by the firewall. When a connection request is received by the firewall, the firewall directs the request to an authentication server, which makes sure that the user sending the request is allowed to connect to the local network protected by the firewall. According to the authentication, the authentication server transmits to the routers of the network a message which defines a policy profile of the connecting user. For example, a policy profile may define that the user is allowed to connect only to specific computers within the network, to receive a specific QoS and/or to use only specific protocols. When the remote user disconnects, the firewall notifies the authentication server which instructs the routers to remove the connections of the user from their internal tables.

This procedure requires, for each connection, transmission of messages between the firewall and the routers. The transmission of these messages takes time and therefore may incur a delay in the responses provided to clients. In addition, when messages are received at different times by different entities of the network, different entities may apply contradicting policies to packets of a client. In addition, the routers need to manage large policy enforcement tables, which have room for the maximal number of connections operating concurrently.

### SUMMARY OF THE INVENTION

An aspect of some embodiments of the present invention relates to a local network in which the routers, switches and/or other network elements are preconfigured with specific IP addresses and policy rules that are to be applied to packets having those addresses. At least some of the packets entering the network undergo a process of replacing their source IP address, to one of the specific preconfigured IP addresses, according to the policies the packets are to receive. The use of a field of the packets to convey the policy profile to be applied to the packets eliminates the need to transmit control packets between entities of the network for each connection.

There is therefore provided in accordance with an exemplary embodiment of the invention, a method of providing policy enforcement within a network, comprising receiving a packet by a first network element at an entrance to the network, replacing a value of an address field of the packet to an internal address related to a policy profile according to which the packet is to be handled, forwarding the packet to a second network element in the network; and handling the packet in accordance with a policy profile determined from the internal address in the address field of the packet.

Optionally, replacing the value of the address field comprises replacing the value of a source address field for packets generated outside the network. Optionally, the method includes replacing the value of a destination address field of packets generated within the network.

Optionally, the method includes replacing the value of at least one field in addition to the field changed to the internal address. Optionally, the at least one additional field comprises an additional address field and/or a protocol port field. Optionally, the at least one additional field is changed to a value not related to the policy profile of the packet. Optionally, the internal address is selected responsive to a previously performed authentication session with a client that transmitted the packet. Optionally, the authentication session determines a single internal address to be used by the client, for all connections of the client.

Optionally, the single internal address may be used by a plurality of different clients deserving a same policy profile. Optionally, the authentication session determines one or more internal addresses to be used by the client, depending on the number of profiles required by different types of connections of the client. Optionally, handling the packet in accordance with the policy profile comprises handling in accordance with a rule set transmitted to the second network element responsive to the authentication session. Optionally, the internal address is assigned to a client that transmitted the packet and the internal address is not used by other clients as long as the client is connected to the network. Optionally, the internal address is not used by other clients even when the client is not connected to the network.

Optionally, handling the packet in accordance with the policy profile comprises handling in accordance with a rule set configured into the second network element by a system manager. Optionally, handling the packet in accordance with the policy profile comprises handling in accordance with a rule set configured into the second network before any packets were received by the first network element from the client that transmitted the received packet. Optionally, handling the packet in accordance with the policy profile comprises determining whether to forward the packet towards its destination. Optionally, handling the packet in accordance with the policy profile comprises handling with a QoS of the policy profile.

Optionally, handling the packet in accordance with the policy profile comprises handling with the same policy profile as packets directed in an opposite direction on a same two-way connection as the received packet. Optionally, handling the packet in accordance with the policy profile comprises handling with a different policy profile than packets directed in an opposite direction on a same two-way connection as the received packet.

There is further provided in accordance with an exemplary embodiment of the invention, a network element, comprising a input interface adapted to receive packets, a replacement unit adapted to replace a source address field of the packets with respective internal addresses; and a policy determination unit adapted to determine policy profiles of clients and to configure the replacement unit with internal addresses to be inserted into packets received from clients according to the determined policy profiles of the clients.

Optionally, the replacement unit is adapted to replace at least one additional field of the packets. Optionally, the replacement unit is adapted to replace the internal addresses back to the replaced values of the source address field.

There is further provided in accordance with an exemplary embodiment of the invention, a method of providing policy enforcement within a network, comprising receiving a packet by a first network element at an entrance to the network, assigning a value related to a policy profile according to which the packet is to be handled to a virtual local area network (VLAN) field of the packet, forwarding the packet to a second network element in the network; and handling the packet in accordance with a policy profile determined from the value assigned to the VLAN field of the packet.

Optionally, assigning the value to a VLAN field comprises replacing an existing value. Alternatively or additionally, assigning the value to a VLAN field comprises adding a portion including a VLAN field to the packet and assigning the value to the VLAN field of the added portion.

There is further provided in accordance with an exemplary embodiment of the invention, a method of changing packet addresses, comprising receiving a packet by a first network element, selecting an address to which an address field of the packet is to be changed, based on a value of at least one field of the received packet, and replacing the value of the address field of the packet to the selected address.

Optionally, selecting the address comprises selecting an address at least partially based on at least one of a source or destination address of the received packet and/or a protocol of the received packet. Optionally, selecting the address comprises selecting an address at least partially based on login information received from the client from which the received packet was received. Alternatively or additionally, selecting the address comprises selecting an address at least partially based on a web page requested by the client from which the received packet was received.

### BRIEF DESCRIPTION OF FIGURES

Particular exemplary embodiments of the invention will be described with reference to the following description of embodiments in conjunction with the figures, wherein identical structures, elements or parts which appear in more than one figure are preferably labeled with a same or similar number in all the figures in which they appear, in which:

FIG. 1 is a schematic block diagram of a network, in which policy enforcement is performed in accordance with an exemplary embodiment of the present invention; and

FIG. 2 is a flowchart of the acts performed by an identification engine, in accordance with an exemplary embodiment of the present invention.

### DETAILED DESCRIPTION OF EMBODIMENTS

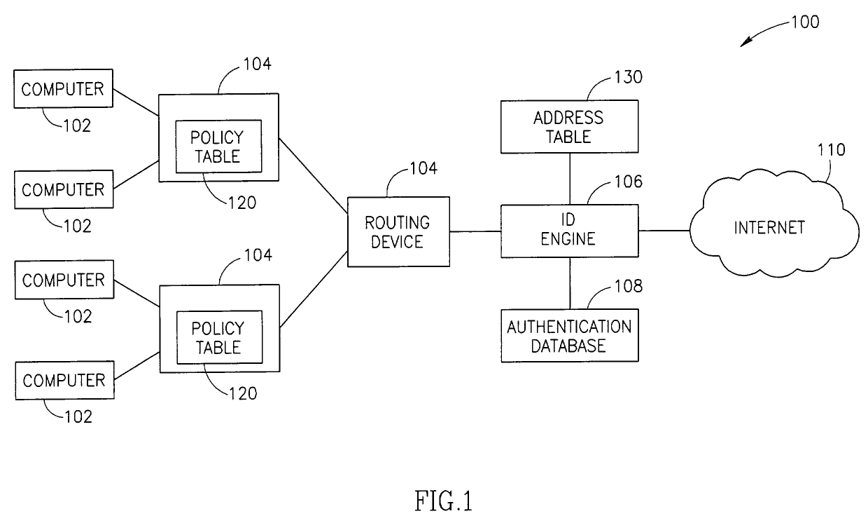

FIG. 1 is a schematic block diagram of a network 100, in which policy enforcement is performed in accordance with an embodiment of the present invention. Network 100 comprises a plurality of computers 102, which may be used as servers, clients and/or for any other tasks. An identification engine 106 (e.g., a firewall), optionally sitting on an edge router, connects network 100 to one or more external networks, such as the Internet 110. One or more routing devices 104 direct packets within network 100 to their destinations and/or toward identification engine 106, according to their addresses. Routing devices 104 may include, for example, routers, layer-2 switches, layer-3 switches, load balancers, proxies and/or any other routing elements. In some embodiments of the invention, identification engine 106 consults an authentication database 108, which stores, for example, lists of users allowed to connect to network 100, the policy these users are to receive and/or login and password information of the users.

In some embodiments of the invention, at least one of routing devices 104 manages a policy enforcement table 120 which includes entries that list identification information and respective policies to be applied to packets matching the identification information. For each packet received, routing devices 104 compare one or more fields of the packet to the entries of table 120 in order to find a match that indicates the policy to be applied to the packet. In some embodiments of the invention, routing devices 104 do not require any hardware changes, relative to devices known in the art, in order to operate in accordance with the present invention.

In some embodiments of the invention, the identification information of an entry includes an IP address which is matched to the source or destination IP address field of packets corresponding to the entry. Optionally, packets directed from outside of network 100 to the network are identified according to their source IP address field and packets directed from network 100 are identified according to their destination IP address field. Optionally, routing devices 104 differentiate between the directions of the packets (e.g., into network 100 or out of the network) according to the physical ports through which the packets are received and/or the virtual LANs (VLANs) on which the packets are received. Alternatively or additionally, both the source and destination IP address fields of received packets are compared to the IP addresses listed in table 120 and an entry is considered matching when a match is found, regardless of the direction of the packet. This alternative is optionally used when opposite direction connections belonging to a same two-way connection are to receive the same policy profile.

In some embodiments of the invention, a system manager defines a plurality of policy profiles and respective internal IP addresses to be assigned to packets that are to be handled according to these policy profiles. For each internal IP address, tables 120 of routing devices 104 are configured with handling rules they are to apply to packets carrying the internal IP address according to the respective policy profile of the internal IP address. The configuration may be performed on each routing device 104 separately or may be managed from a central unit (e.g., identification engine 106) running a suitable policy insertion software, which receives the policy profiles and accordingly transmits configuration data to each of routing devices 104.

The configuration is performed, in some embodiments of the invention, at a setup stage of network 100. Alternatively or additionally, the configuration of routing devices 104 is performed, for at least some internal IP addresses, responsive to receiving connection requests directed to network 100.

In some embodiments of the invention, the internal IP addresses used in representing policy profiles are addresses which generally do not enter network 100 from Internet 110. For example, identification engine 106 may prevent entrance of packets having source addresses matching the internal IP addresses of network 100 or may replace their source address field to different values. Alternatively or additionally, the internal IP addresses are addresses generally not used for communication between LANs, e.g., addresses of the form 10.x.x.x. Therefore, when a packet carrying an internal IP address is received by a routing device 104 it is assumed that the address was generated within network 100, for example by identification engine 106, as described below.

In some embodiments of the invention, identification engine 106 manages an address changing table 130, which is used in replacing client addresses with internal IP addresses, and vice versa, as described hereinbelow.

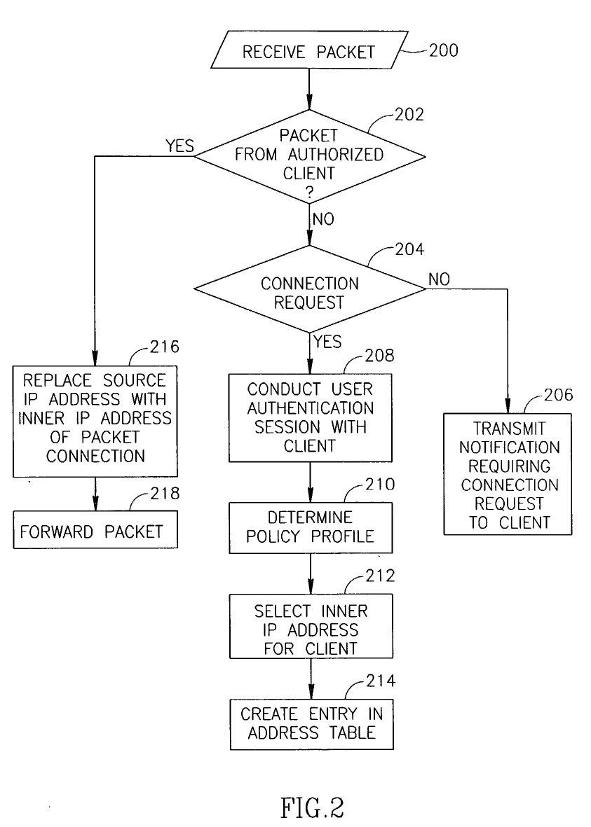

FIG. 2 is a flowchart of acts performed by identification engine 106, in accordance with an embodiment of the present invention. Upon receiving (200) a packet from Internet 110, identification engine 106 determines whether (202) the packet belongs to an authorized client. If (202) the packet does not belong to an authorized client, identification engine 106 determines whether (204) the packet comprises a request to connect to network 100. If (204) the packet is not a network connection request, a notification that a connection request is required is transmitted (206) to the client generating the packet. Alternatively, the packet is simply discarded. If (204) the packet is a network connection request, a user authentication session is conducted (208) with the client sending the packet. Upon completion of the authentication, a policy profile is optionally determined (210) for the client, based on a preconfigured record of the client, based on the authentication session and/or based on any other information, such as described below. In some embodiments of the invention, according to the determined policy profile, an internal IP address is selected (212) for the client. An entry in address changing table 130 is optionally generated (214) for the client for handling of subsequent packets sent to and/or received from the client.

If (202) the packet belongs to an authorized client, identification engine 106 optionally replaces (216) the source IP address of the packet with the internal IP address assigned to the connection of the packet, using an entry of the client in address changing table 130. Replacement (216) is optionally performed using field replacement methods known in the art to be used by proxies and load balancers. The packet is then forwarded (218) into network 100 towards its destination.

In some embodiments of the invention, packets passing through identification engine 106 toward Internet 110 undergo an opposite replacement procedure, in which the internal destination address they carry is replaced by the IP address of the client to which the packet is directed. Optionally, the direction of the packet is determined according to the physical port through which the packet was received and/or the VLAN to which the packet belongs.

Referring in more detail to determining whether (202) a packet belongs to an authorized client, identification engine 106 optionally checks whether the connection of the packet has an entry in address changing table 130. In some embodiments of the invention, identification engine 106 checks that received packets adhere to protocol rules, and/or performs others tests known in the art to be performed by firewalls or other security network elements.

Referring in more detail to conducting (208) the user authentication session, substantially any authentication method known in the art may be used, such as using the RADIUS service. The authentication may be performed, for example, in accordance with a web-portal login procedure, or any other login procedure. In some embodiments of the invention, the authentication session is managed by identification engine 106. Alternatively, the authentication session is managed by a separate login server (not shown).

Referring in more detail to determining (210) a policy profile for the client, in some embodiments of the invention, the policy profile includes the computers 102 the client is allowed to access, the QoS the client is to receive and/or whether the packets from/to the client are to be logged. Alternatively or additionally, the policy profile includes which (if any) counting and/or billing procedures are to be applied to packets of the client. Further alternatively or additionally, any other policies known in the art may be included in the determined policy profile.

In some embodiments of the invention, the policy profile indicates different handling rules for different packets. For example, HTTP and/or TCP packets of the client may be allowed to access a first set of computers, while other packets are allowed to access a second set of computers. Alternatively or additionally, different routing devices 104 apply different policies to the packets of the client. For example, a first group of routing devices 104 may apply a high QoS to the packets of the client, while a second group of routing devices 104 apply a normal QoS to the packets of the client.

In some embodiments of the invention, authentication database 108 is configured, for at least some of the clients, with a policy profile of the client. Upon authenticating the client, the client profile is retrieved from database 108 and is passed to identification engine 106. Alternatively or additionally, the policy profile is determined based on information received from the client, such as the destination computer 102 and/or the specific web page the client wants to access. Alternatively or additionally, the policy profile is determined based on a cookie in the client's request, which may describe, for example, the previous pages accessed by the client.

In some embodiments of the invention, identification engine 106 initiates, for some clients, a registration process in which a policy profile is chosen for the client. Optionally, a single user may have different profiles depending on the authentication procedure. For example, a first policy profile may be used for regular conditions, while a second policy profile allowing more access is allowed only when a special authentication procedure is performed.

In some embodiments of the invention, all the connections of the same client have the same policy profile. Alternatively, different connections of a single client may have different profiles. Optionally, in this alternative, identification engine 106 identifies new connection requests received through Internet 110 and for each connection determines a respective policy profile. Optionally, new connections of the TCP protocol are identified based on the SYN flag of the TCP header. In some embodiments of the invention, a general policy profile is defined for the client along with one or more specific profiles for specific protocols or connections of the client.

Referring in more detail to selecting (212) an internal IP address, in some embodiments of the invention, each client is assigned one or more specific internal IP addresses which the client is to receive each time it connects to network 100. Optionally, the client has a specific internal IP address for each policy profile of the client. Alternatively, the client has a single internal IP address and only one profile.

Optionally, the first time the client connects to network 100, an unused internal IP address matching the profile of the client is assigned to the client. In some embodiments of the invention, devices 104 are configured with the profile before the client first connects to network 100. The selected internal IP address is optionally stored in a record of the client in authentication database 108, for use at later times in which the client connects to network 100. If an internal IP address having the profile required by the client does not exist, an unused internal IP address with a different profile or without a profile is redefined (or defined) to the profile of the client and is assigned to the client.

Alternatively, for each policy profile, regardless of the number of clients using the profile, a specific internal IP address is allocated. Optionally, identification engine 106 monitors the source port addresses, such that two connections having the same policy profile do not have the same source port at the same time. Alternatively, the monitoring is performed to make sure that two connections do not have the same set of source and destination IP addresses and protocol ports, at the same time. If necessary, identification engine 106 optionally changes the source port together with changing the source IP address. Alternatively, identification engine 106 substantially always changes the source protocol port, for example, substituting with port numbers assigned sequentially.

Alternatively or additionally to assigning a single internal IP address to all clients and/or connections having a same profile, a set or range of IP addresses is assigned to one or more of the profiles. When a client having a specific profile connects to network 100, one of the IP addresses in the range is assigned to the client.

In some embodiments of the invention, defining a profile for an internal IP address comprises transmitting a message to each of routing devices 104 with the internal IP address and the respective handling rules the device 104 is to apply to packets carrying the internal IP address in accordance with the policy. Optionally, a separate message is transmitted to each routing device 104 with its specific instructions. Alternatively or additionally, one or more broadcast and/or multicast messages are transmitted to some or all of the routing devices 104. For example, a multicast group of routing devices 104 may be defined, and policy update messages are transmitted to this multicast group. In some embodiments of the invention, when an internal IP address is to be defined with the same policy as a different internal IP address, already defined, a message notifying the devices 104 that the internal IP addresses are to have the same policy is transmitted by identification engine 106. In some embodiments of the invention, identification engine 106 also stores the policy profile defined for each internal IP address.

Optionally, routing devices 104 are configured with a default rule set for unrecognized packets. For example, such packets may be discarded, logged and/or allowed to be forwarded only to specific areas of network 100. Alternatively or additionally, routing devices 104 are configured to transmit queries to identification engine 106 when a packet with an unidentified IP address (in the source or destination field depending on the direction of the packet) is received.

In some embodiments of the invention, all profiles defined are static profiles which are not erased unless specific instructions are received to this effect from a system manager. Alternatively, some of the policy profiles, for example those defined automatically responsive to a user request, are defined as volatile profiles which are erased after a predetermined time and/or after a predetermined time of not being used. Volatile profiles may be used in order to enhance the security of network 100. Further alternatively or additionally, policy profiles are canceled when the resources of routing devices 104 and/or identification engine 106 require cancellation of one or more policy profiles in order to make room for other profiles. The canceled policy profile is optionally selected according to any known criteria, such as the oldest and/or the least used.

Referring in more detail to generating (214) an entry in table 130, in some embodiments of the invention, each entry includes identification information of the packets matching the entry and an internal IP address to be used by the packets within network 100. Optionally, as described above, the identification information includes the source IP address of the packets. Thus, all the packets from the same IP address have the same internal IP address and the number of entries in table 130 is relatively small. Alternatively or additionally, the identification information includes both the source and destination IP addresses, such that when a client establishes connections with different computers 102 in network 100, each connection may have a different policy profile. Further alternatively or additionally, the identification information includes the protocol, the source protocol port and/or the destination protocol port of the packets, such that different connections of a client to the same computer may have different policy profiles. Further alternatively or additionally, any of the table organizations described in U.S. patent application Ser. No. 09/596,003, filed Jun. 15, 2000, and/or in U.S. patent application Ser. No. 09/653,656, filed Sep. 1, 2000, the disclosures of which are incorporated herein by reference, may be used. In an exemplary embodiment of the invention, different entries of table 130 have different identification information according to the needs of the clients.

In some embodiments of the invention, identification engine 106 monitors the usage of the different entries and entries not used for a predetermined time are removed. Alternatively or additionally, identification engine 106 monitors the packets passing on the connections in order to determine when a connection is disconnected. When a connection is determined to be disconnected the respective entry is optionally removed from table 130. The removal of the entries adds to the security of network 100 and prevents the clogging of table 130. In some embodiments of the invention, before removing the entry from table 130, the client is queried in order to make sure that connection with the client was actually disconnected.

Referring in more detail to replacing (216) the source IP address, in some embodiments of the invention, only the client IP address is replaced with the respective internal IP address. Alternatively or additionally, also the destination IP address is replaced. Further alternatively or additionally, also the source and/or destination protocol port fields are replaced. Further alternatively or additionally, for one or more of the connections, identification engine 106 changes the DSCP field of the packets so that it matches the profile of the packet. Further alternatively or additionally, any other replacement methods are used, such as half NAT, full NAT and/or splicing methods may be used. In some embodiments of the invention, identification engine 106 serves additionally as a proxy and/or load balancer, which perform field replacement for reasons other than for policy enforcement.

In some embodiments of the invention, the replacement of the source IP address (216) is accompanied by changing other fields related to the source IP address. For example, the replacement may include changing IP addresses and/or port values stated in messages of an FTP control channel. This replacement may be performed using any method known in the art.

In handling secure connections, for example in accordance with the HTTPS protocol and/or the IPsec protocol, the replacement (216) optionally includes performing procedures for handling secure connections. Optionally, for secure connections, identification engine 106 operates as a tunnel endpoint and/or as a proxy, as is known in the art.

In some embodiments of the invention, one or more of routing devices 104 includes a hardware unit which accesses the IP address for the operation of the device. Optionally, the same hardware unit is used to access the IP source address for determining the policy of the packet. Alternatively or additionally, in the same data access, the source IP address is consulted both for the device specific task and for the policy determination.

In some embodiments of the invention, routing devices 104 may be configured to have different handling rules for packets having the same IP address, according to one or more other fields of the packets. For example, the policy profile of a specific IP address may state that TCP packets are to be forwarded while UDP packets are to be discarded.

In the above description, the IP source address field is used to transfer policy information throughout network 100. The use of the IP address field provides a very large number of different policy profiles. For example, the range 10.x.x.x provides 2\hat{ }24 different possible profiles, such that each client can have a different profile. In other embodiments of the invention, the DSCP field may be used to designate the different profiles. It is noted, however, that the use of the DSCP field may be problematic with certain network devices and/or computers which are preconfigured to use the DSCP field for its conventional use. In other embodiments of the invention, the 802.1p Priority Tag field and/or the 802.1q VLAN ID tag field are used to transfer policy information throughout the network. Identification engine 106 may change the value of an existing VLAN field of received packets and/or may tag VLAN field portions to the received packets and assign a policy related value to the added field. As with the DSCP field, this may limit the internal elements of the network to specific elements that do not use these fields and/or may require appropriate configuration of the internal elements.

In still other embodiments of the invention, the source protocol port is used to transfer the policy information. The source port field is changed by identification engine 106, such that within network 100 the source port field has a value that reflects the policy of the connection. In some embodiments of the invention, a plurality of the above fields are used to reflect the policy profile of the packets. For example, the source IP address and the source port may be used. In an exemplary embodiment of the invention, the source IP address identifies the client and the source port identifies the specific policy profile of the client when the client has a plurality of profiles.

It will be appreciated that the above described methods may be varied in many ways, including, changing the order of steps, and/or performing a plurality of steps concurrently. The present invention may be used with substantially any protocol, including IP, TCP, FTP, HTTP, and HTTPS. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. For example, although in the above description the field changing task is performed by identification engine 106, this task may be performed by substantially any other network element, such as an edge router, a load balancer and/or a proxy. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of providing policy enforcement within a network, comprising:
receiving a packet by a first network element at an entrance to the network;
replacing a value of an address field of the packet to an internal address related to a policy profile according to which the packet is to be handled;
forwarding the packet to a second network element in the network; and
handling the packet in accordance with a policy profile determined from the internal address in the address field of the packet.

2. A method according to claim 1, wherein replacing the value of the address field comprises replacing the value of a source address field for packets generated outside the network.

3. A method according to claim 1, comprising replacing the value of a destination address field of packets generated within the network.

4. A method according to claim 1, comprising replacing the value of at least one field in addition to the field changed to the internal address.

5. A method according to claim 4, wherein the at least one additional field comprises an additional address field.

6. A method according to claim 4, wherein the at least one additional field comprises a protocol port field.

7. A method according to claim 4, wherein the at least one additional field is changed to a value not related to the policy profile of the packet.

8. A method according to claim 1, wherein the internal address is selected responsive to a previously performed authentication session with a client that transmitted the packet.

9. A method according to claim 8, wherein the authentication session determines a single internal address to be used by the client, for all connections of the client.

10. A method according to claim 8, wherein the single internal address may be used by a plurality of different clients deserving a same policy profile.

11. A method according to claim 8, wherein the authentication session determines one or more internal addresses to be used by the client, depending on the number of profiles required by different types of connections of the client.

12. A method according to claim 8, wherein handling the packet in accordance with the policy profile comprises handling in accordance with a rule set transmitted to the second network element responsive to the authentication session.

13. A method according to claim 1, wherein the internal address is assigned to a client that transmitted the packet and the internal address is not used by other clients as long as the client is connected to the network.

14. A method according to claim 13, wherein the internal address is not used by other clients even when the client is not connected to the network.

15. A method according to claim 1, wherein handling the packet in accordance with the policy profile comprises handling in accordance with a rule set configured into the second network element by a system manager.

16. A method according to claim 1, wherein handling the packet in accordance with the policy profile comprises handling in accordance with a rule set configured into the second network before any packets were received by the first network element from the client that transmitted the received packet.

17. A method according to claim 1, wherein handling the packet in accordance with the policy profile comprises determining whether to forward the packet towards its destination.

18. A method according to claim 1, wherein handling the packet in accordance with the policy profile comprises handling with a QoS of the policy profile.

19. A method according to claim 1, wherein handling the packet in accordance with the policy profile comprises handling with the same policy profile as packets directed in an opposite direction on a same two-way connection as the received packet.

20. A method according to claim 1, wherein handling the packet in accordance with the policy profile comprises handling with a different policy profile than packets directed in an opposite direction on a same two-way connection as the received packet.

21. A network element, comprising:
a input interface adapted to receive packets;
a replacement unit adapted to replace a source address field of the packets with respective internal addresses; and
a policy determination unit adapted to determine policy profiles of clients and to configure the replacement unit with internal addresses to be inserted into packets received from clients according to the determined policy profiles of the clients.

22. A network element according to claim 21, wherein the replacement unit is adapted to replace at least one additional field of the packets.

23. A network element according to claim 21, wherein the replacement unit is adapted to replace the internal addresses back to the replaced values of the source address field.

24. A method of providing policy enforcement within a network, comprising:
receiving a packet by a first network element at an entrance to the network;
assigning a value related to a policy profile according to which the packet is to be handled to a virtual local area network (VLAN) field of the packet;
forwarding the packet to a second network element in the network; and
handling the packet in accordance with a policy profile determined from the value assigned to the VLAN field of the packet.

25. A method according to claim 24, wherein assigning the value to a VLAN field comprises replacing an existing value.

26. A method according to claim 24, wherein assigning the value to a VLAN field comprises adding a portion including a VLAN field to the packet and assigning the value to the VLAN field of the added portion.

27. A method of changing packet addresses, comprising:
receiving a packet by a first network element;
selecting an address to which an address field of the packet is to be changed, based on a value of at least one field of the received packet; and
replacing the value of the address field of the packet to the selected address.

28. A method according to claim 27, wherein selecting the address comprises selecting an address at least partially based on at least one of a source or destination address of the received packet.

29. A method according to claim 27, wherein selecting the address comprises selecting an address at least partially based on a protocol of the received packet.

30. A method according to claim 27, wherein selecting the address comprises selecting an address at least partially based on login information received from the client from which the received packet was received.

31. A method according to claim 27, wherein selecting the address comprises selecting an address at least partially based on a web page requested by the client from which the received packet was received.
